(19) United States
(12) Patent Application Publication
(10) Pub. No.: US 2015/0344336 A1
(43) Pub. Date: Dec. 3, 2015

(54) SYSTEM AND METHOD FOR APPLICATION OF A SUBSTANCE TO A BODY OF WATER

(71) Applicant: Lake Restoration, Inc., Rogers, MN (US)

(72) Inventors: Kevin R. Kretsch, Rogers, MN (US); Paul B. Kretsch, Plymouth, MN (US); Brian K. Kretsch, Plymouth, MN (US)

(21) Appl. No.: 14/586,561

(22) Filed: Dec. 30, 2014

Related U.S. Application Data
(60) Provisional application No. 62/003,964, filed on May 28, 2014.

(51) Int. Cl. C02F 1/50; B63H 7/02; B63B 35/00

(52) U.S. Cl. CPC C02F 1/50; B63B 35/00; B63H 7/02; B63B 2035/008; C02F 2103/007

(57) ABSTRACT

An apparatus includes a remote control boat and a dispenser mounted to the remote control boat.

### PRIORITY

This application claims the benefit of priority of U.S. Provisional Patent Application Ser. No. 62/003,964, entitled “SYSTEM AND METHOD FOR APPLICATION OF A SUBSTANCE TO A BODY OF WATER,” filed on May 28, 2014, which is herein incorporated by reference in its entirety

### FIELD

This application generally relates to water treatment and more specifically to application of an algaecide, herbicide, larvacide, insecticide, or other substance to a body of water.

### BACKGROUND

Substances are added to bodies of water, such as ponds, to control vegetation growth or for other reasons. A typical method of applying such substances is from a spray tank which is carried around the edge of the body of water and sprayed onto the water. It can be difficult to apply herbicide, algaecide or other substances around the edge of a pond or other body of water because of brush, access, etc.

### BRIEF DESCRIPTION OF THE DRAWINGS

FIG. 1 shows an exploded view of a boat with a tank, in accordance with one embodiment.

FIG. 2 shows a side view of the boat of FIG. 1, in assembled form, in accordance with one embodiment.

FIG. 3 shows a rear view of the boat of FIG. 1, in assembled form, in accordance with one embodiment.

FIG. 4 shows a top view of the boat of FIG. 1, in assembled form, in accordance with one embodiment.

FIG. 5 shows a cross section side view of the boat, in accordance with one embodiment.

FIG. 6 shows an exploded perspective view of a tank cover for the boat, in accordance with one embodiment.

FIG. 7 shows an assembled perspective view of the tank cover of FIG. 6.

### DETAILED DESCRIPTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that the embodiments may be combined or that other embodiments may be utilised and that structural changes may be made without departing from the spirit and scope of the present invention. The following detailed description is, therefore, not to be taken in a limiting sense, and the scope of the present invention is defined by the appended claims and their equivalents.

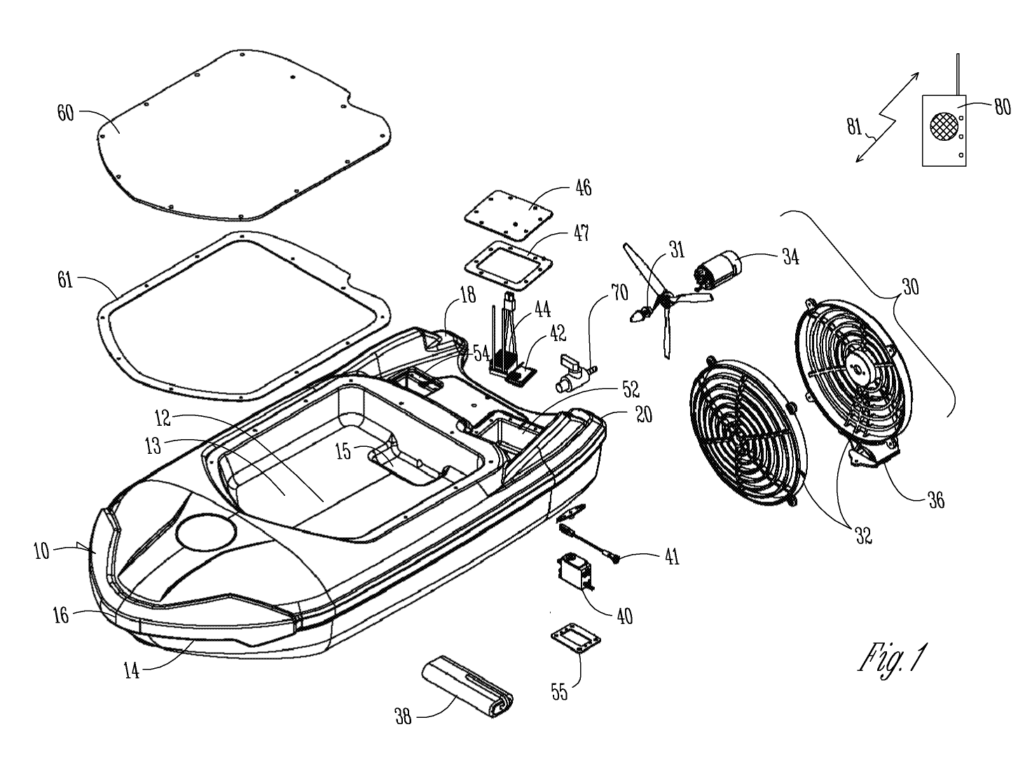

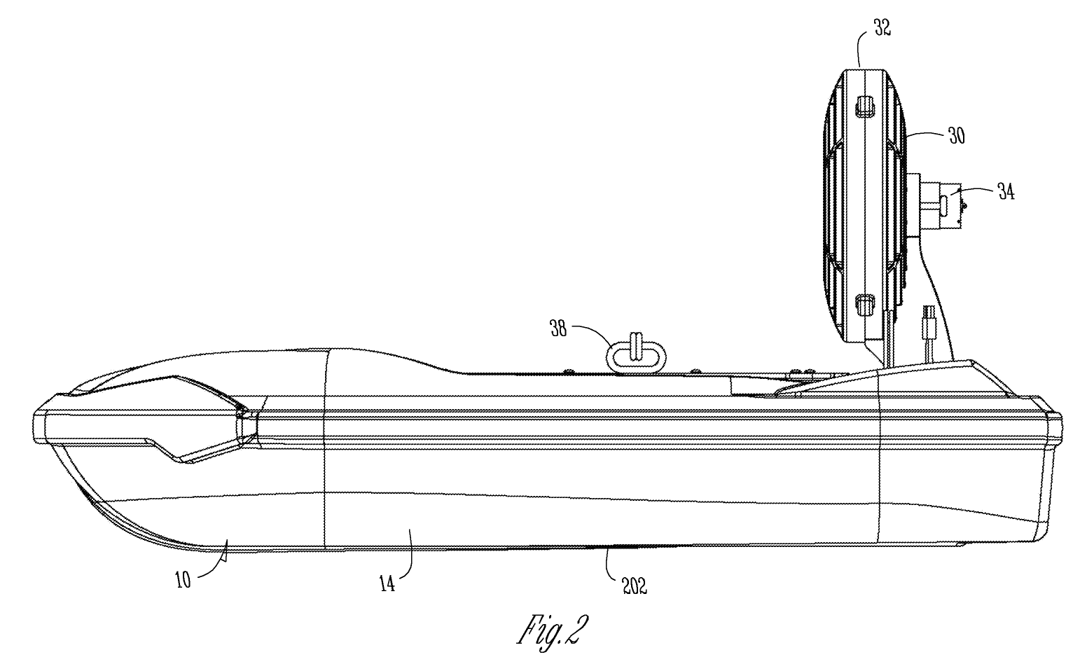

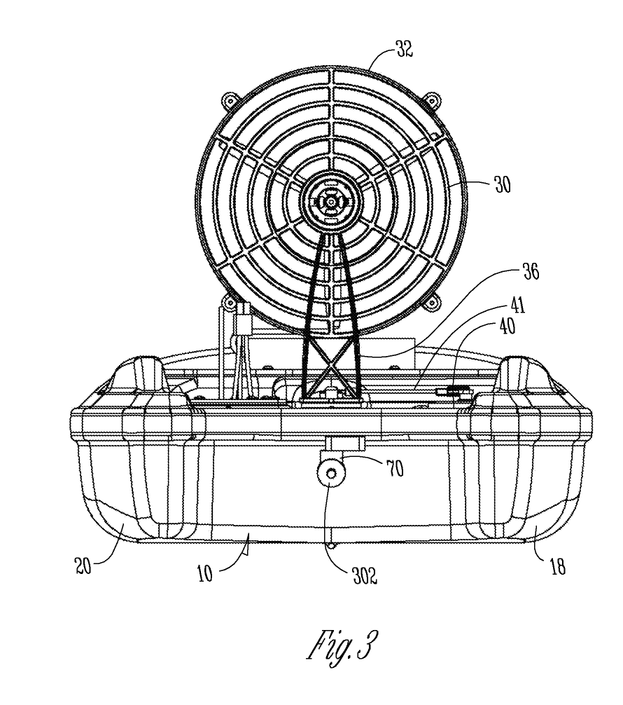

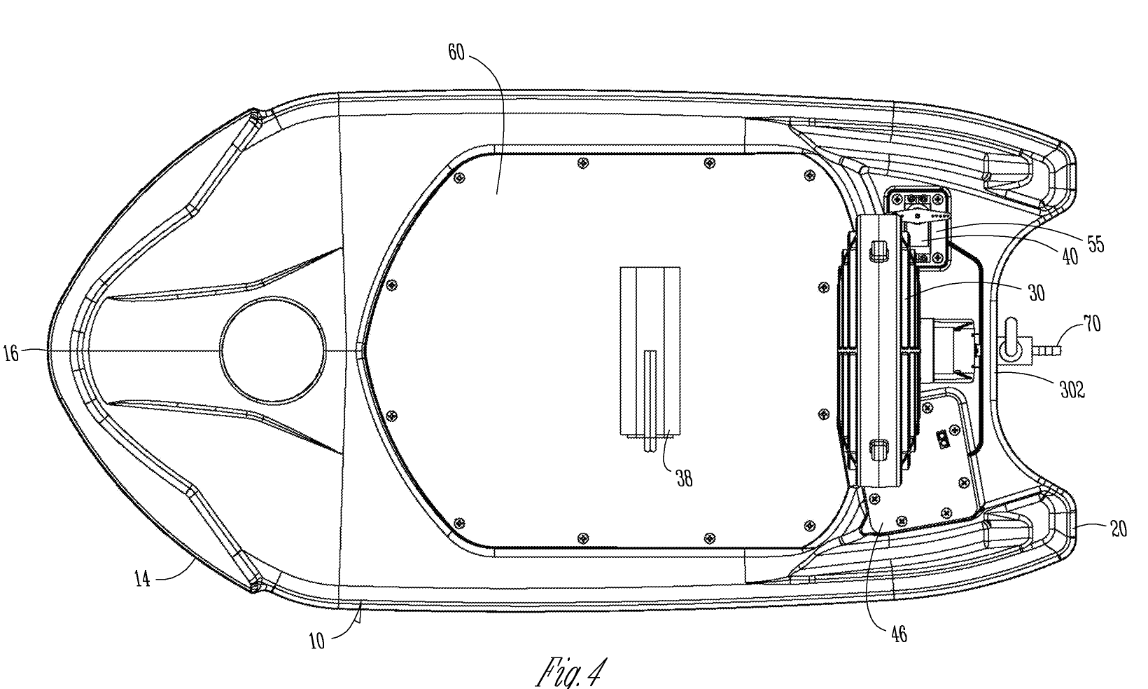

FIG. 1 shows an exploded view of a boat 10 with a dispenser tank 12, in accordance with one embodiment. FIG. 2 shows a side view of the boat 10, FIG. 3 shows a rear view of the boat 10, and FIG. 4 shows a top view of the boat 10.

The boat 10 can be an unmanned remote-controlled boat adapted to apply herbicide (or other substances) that enables ponds and lakes to be treated without launching a manned boat or treating the water body from shoreline.

In one example, the hull 14 of boat 10 can be made of plastic or metal. The boat 10 can have a flat bottom 202 to provide stability when placed on land as well as when filled. The front end 16 of the boat 10 can be pointed to allow the boat 10 to deflect off of obstacles and vegetation and not get stuck. In one example, the boat 10 can be approximately 33 inches long and 16 ½ inches wide. Other examples can use different dimensions. Having an approximate length to width ratio of about 2 to 1 helps aids stability and turning of the boat 10. This enables the boat 10 to maneuver and turn adequately with a full or empty dispenser tank 12. In one embodiment, the boat can about 50 inches long or less, or about 75 inches long or less.

The rear of the boat 10 can have extensions 18, 20 on each side extending further back than an outlet 302 to prevent vegetation from floating into the dispensing area directly behind the outlet 302 (i.e. the spray area). In an example, the boat 10 can have a drain near either of extensions 18, 20 to drain the hull of the boat.

The boat 10 can be powered by an aircraft type propeller, such as a fan 30. The fan 30 propeller 31 can be a three blade propeller with a pitch of 6. The fan 30 can include a tractor or a push propeller. The fan 30 propeller 31 can be encased in a cover 32 to protect the user. The cover 32 and a motor 34 can be mounted on a plastic or other material motor mount 36. The motor 34 can be powered by a battery 38. A battery holder can be located toward the center back of a cover 60 to provide easy access to the battery 38. For example, a plastic holder or Velcro strap can be used to hold the battery 38 in place.

In one option, there can be a servo motor 40 to rotate the fan 30 via a tie rod 41 to allow for steering the boat 10. For example, the motor mount 36 can be rotatably attached to the boat 10. The tie rod 41 has one end coupled to the motor mount 36 and a second end coupled to a lever arm coupled to the servo motor 40. Signals supplied by a user to the servo motor 40 allow for rotation of the fan 30 via the tie rod 41. In another option the boat can have a remotely controlled rudder to allow for steering. In another option, the boat can include two motors powered and controlled independently to enable steering of the boat.

Fan 30 provides an above the water propulsion and steering technique. This can be helpful in lakes with lots of weeds and vegetation to prevent the boat 10 from getting stuck. However, another version of the propulsion method could be a submerged propeller. In other examples, the propellers can be driven by battery, solar or gasoline powered motors.

The remote control boat 10 can include a receiver 42 and a speed controller 44. The receiver can be coupled to the servo motor 40 to allow for signals to be delivered to the servo motor 40 and also connected to the speed controller 44. The speed controller is coupled to motor 34 to allow a user to speed up or slow down the propeller 31, thus controlling the speed of the boat 10. In one example, receiver 42 and speed controller 44 are mounted in a cavity 52 formed in the rear of the boat 10 and covered by a receiver cover 46 having a gasket 47. The servo motor 40 can be mounted within a second cavity 54 in the rear of the boat 10 and at least partially extend through a servo mount panel 55 attached over the cavity 54. In one example, the cavities 52, 54 can be raised and or sloped to prevent water from draining into them.

The dispenser tank 12 can be formed as part of the hull 100 or removable from the boat 10. In one example, the dispenser tank 12 is molded into the boat 10, thus forming a cavity 13 in the hull. In one example, a sump 15 can be formed at a back portion of the tank 12. The dispenser tank 12 can be covered with a cover 60. The cover 60 attaches at the perimeter of the dispenser tank 12 cavity 13 with a gasket 61 between the cover 60 and the boat 10.

An outlet 302 at the back surface of the boat 10 allows for dispensing of material from tank 12. In one example, a valve 70 can be attached at outlet 302 to allow for controlled dispensing and/or draining of the materiel in the tank 12.

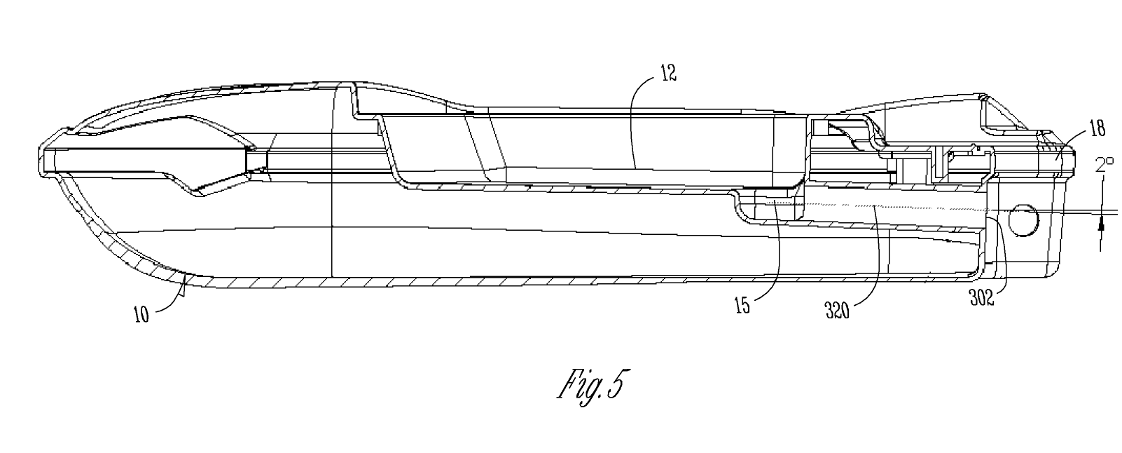

Referring now also to FIG. 5, which shows a cross section side view of the boat 10, a drain tube 320 extends between the sump 15 of the tank 12 and the outlet 302 at the back of the boat 10. The tank 12 can be sloped to enable liquid in the tank 12 to drain into the sump 15. The sump 15 provides a means to keep the flow of the substance at a fairly even rate as the level in the tank 12 decreases. The sump 15 also provides additional pressure on the liquid out the outlet 302 at the back of the boat 10 into the lake or pond.

The drain tube 320 from the sump 15 to the exterior is at a slight downward angle. This increases the pressure on the liquid out the outlet 302 at the back of the boat 10. The drain tube 320 can be about ⅜″ diameter to provide an even flow for treating an average sized pond.

In an example, the valve 70 can be placed at the tube outlet 14 to shut off the liquid flow or to increase or decrease the flow. In one example, the valve 70 can be controlled remotely to increase or decrease the opening and the flow. In one example, a hand pump can be attached to the tank 12 to provide additional pressure as needed to increase the spray distance from the back of the boat 10. The solution to be applied: for example, algaecide, herbicide, larvacide, insecticide, or water clarifier, or other substances can be added to tank 12.

In one example, the hand pump can pressurize the tank and force the solution out on or into the water body. In another version, an electric or gas powered sprayer can force the solution out or into the water body. Gravity can also provide the means to force the solution out into the body of water. In some options, a nozzle or drop hose can be attached at outlet 302 and be used to eject or spray the solution onto the pond. Another example can provide drop hoses off the boat 10 to inject the solution.

If the product to be applied to the body of water is granular, a hopper and spreader may be used. A conveyor belt can be an alternative method.

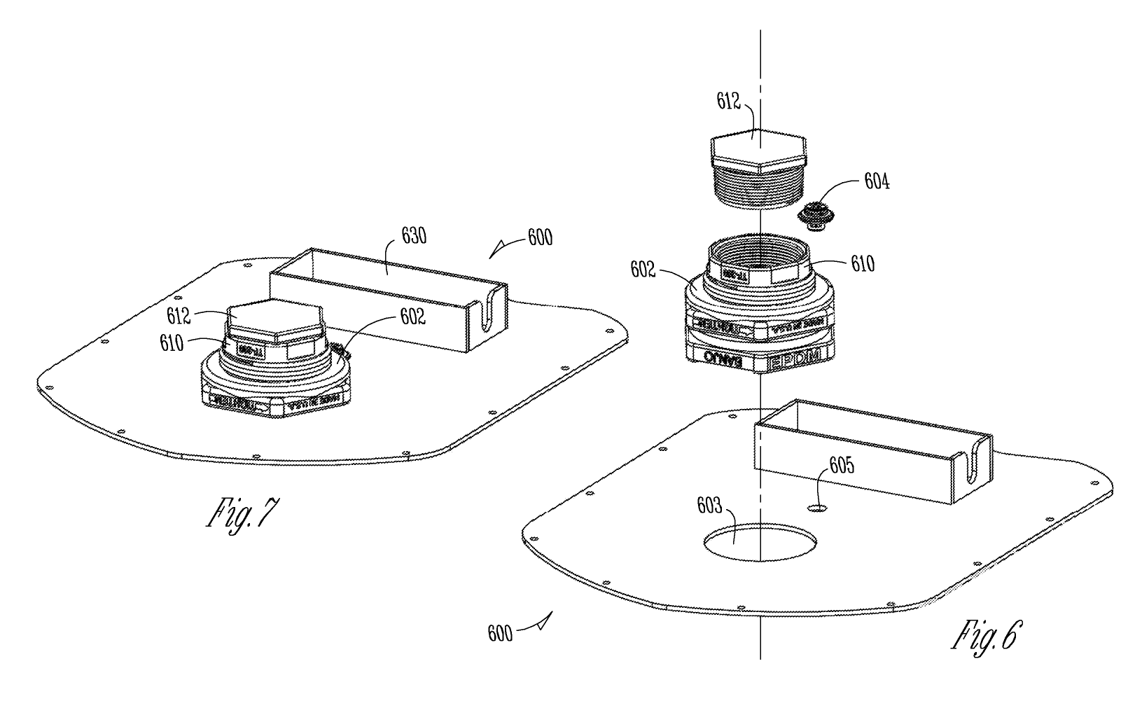

FIG. 6 shows an exploded perspective view of a tank cover 600 for the boat 10, in accordance with one embodiment, and FIG. 7 shows an assembled perspective view of the tank cover 600. The cover 600 includes a fill cap 602 which attaches at a hole 603 and a vent plug 604 that attaches at a hole 605. The fill cap 602 includes a plug 612 which is removed to allow for filling of the tank. Vent plug 604 can be removed during use to allow air into the tank as the product drains. In another option, a single vented fill cap can be utilised. In some embodiments, the fill cap 602 can be a drain plug, a fuel cap on an acrylic neck, or other design. The cap 602 can be connected to the boat by a vertical neck 610 that allows the boat to be placed on uneven ground and not spill the contents of the tank. A battery holder 630 can be formed on the cover 600.

In use, a user fills tank 12 with the proper substance of use (algaecide, herbicide, larvacide, insecticide, or water clarifier, or other substances). The boat is placed in the water. The route the boat 10 takes on the water could be determined by remote controls and a signal sent to the boat from the shore, for example from a controller 80 that can communicate to the receiver 42 on the boat 10 via signals 81. Thus, the user manually and remotely drives the boat around the body of water, controlling the direction and speed of the boat. The substance is dispensed out of the outlet 302 via drain tube 320 as discussed above.

In another option, the boat 10 can by preprogrammed to follow a predetermined route on the water body. In other examples, the boat 10 can use GPS or cellular signals to adjust route per programming.

The above description is intended to be illustrative, and not restrictive. Many other embodiments will be apparent to those of skill in the art upon reviewing the above description. The scope of the invention should, therefore, be determined with reference to the appended claims, along with the full scope of equivalents to which such claims are entitled.

What is claimed is:

1. An apparatus comprising:
a remote control boat; and
a dispenser mounted to the remote control boat.

2. The apparatus of claim 1, wherein the dispenser includes a tank configured to hold a dispensable substance.

3. The apparatus of claim 2, wherein the tank is molded as a portion of the boat.

4. The apparatus of claim 2, wherein the tank includes a vented fill cap.

5. The apparatus of claim 1, wherein the boat includes a flat bottom.

6. The apparatus of claim 1, wherein the boat has an approximate length to width ratio of about 2 to 1.

7. The apparatus of claim 1, wherein the boat includes a sump and a drain tube configured to release a substance from the dispenser, wherein the drain tube end at an outlet at a back end of the boat.

8. The apparatus of claim 7, wherein the boat includes at least two extensions at a back of the boat and located such that the outlet of the drain tube is between the at least two extensions.

9. The apparatus of claim 1, wherein the boat is powered by an above-water fan propeller.

10. The apparatus of claim 1, wherein the fan propeller is rotatable to allow for steering of the boat.

11. The apparatus of claim 1, wherein the boat includes a receiver to receive signals from a remote control controller.

12. An apparatus comprising:
a remote control boat; and
a tank on the boat configured to hold a dispensable substance; and
a drain tube connected to the tank and configured to release the dispensable substance.

13. The apparatus of claim 12, wherein the tank is molded as a portion of the boat.

14. The apparatus of claim 12, wherein the tank includes a vented fill cap.

15. The apparatus of claim 12, wherein the boat includes a flat bottom.

16. The apparatus of claim 12, wherein the boat has an approximate length to width ratio of about 2 to 1.

17. The apparatus of claim 12, wherein the drain tube includes an outlet at a back end of the boat, and wherein the boat includes at least two extensions at the back of the boat and located such that the outlet is between the at least two extensions.

18. The apparatus of claim 12, wherein the boat is powered by an above-water fan propeller.

19. The apparatus of claim 12, wherein the boat includes a receiver to receive signals from a remote control controller.

20. A method comprising:
filling a remote-controlled boat with a dispensable substance; and
delivering the substance around a body of water using the remote-controlled boat.
